(19) United States
(12) Patent Application Publication
(10) Pub. No.: US 2026/0011950 A1
(43) Pub. Date: Jan. 8, 2026

(54) WATERPROOF STRUCTURE FOR A TRANSMISSION CABLE

(71) Applicant: Su-Dong Chen, Xingning City (CN)

(72) Inventor: Su-Dong Chen, Xingning City (CN)

(21) Appl. No.: 18/764,390

(22) Filed: Jul. 5, 2024

(51) Int. Cl. H01R 13/52; H01B 7/282

(52) U.S. Cl. CPC H01R 13/5205; H01B 7/282

(57) ABSTRACT

A waterproof structure for a transmission cable includes a transmission cable which includes a transmission head and a connecting wire. The transmission head includes a plug segment and a neck segment. A sleeve has a through hole defined axially therethrough, and the sleeve is mounted to the plug segment of the transmission cable. Multiple ribs are circumferentially formed on an outer peripheral surface of the sleeve. Each rib extends outwardly from the outer peripheral surface of the sleeve. The ribs are spaced apart from the others. Each rib is deformed when subjected to pressure. When the transmission cable is inserted into a socket, any of the ribs can seal the socket interface according to the depth of insertion, so as to effectively prevent external moisture, liquids, and other contaminants from entering the socket.

### FIELD OF THE INVENTION

The present invention relates to a transmission cable, and more particularly, to a waterproof structure for a transmission cable used for the transmission of electrical power and signals in electrical devices.

### BACKGROUND OF THE INVENTION

With the rapid development of modern technology, many electronic devices can transmit information to each other. Electrical connectors act as a bridge for signal transmission between electrical devices. Examples include network cable sockets (RJ-45), telephone line sockets (RJ-11), Universal Serial Bus (USB) connectors, and FireWire (IEEE1394/FireWire) connectors. These serial interface connectors are ubiquitous in urban life.

However, because electrical signals are transmitted through these electrical connectors, when transmission cables are affected by external environmental factors such as moisture, liquids, oil stains, or dust, the electrical signals can be severely disrupted. This can result in unstable signal transmission or even cause the lines to be corroded by moisture, leading to malfunction or inability to transmit. This issue is particularly common in outdoor activities like camping, where many electrical devices are exposed to the natural environment. The high moisture content in the air can easily allow moisture to enter between the socket and the transmission cable plug, and other liquids may also seep in, causing the aforementioned problems. Furthermore, due to the convenience of mobile electronic devices, users often carry their electronic products to various outdoor occasions. Therefore, when connecting to other devices through electrical connectors, it is essential to pay attention to the protection of the connectors themselves to avoid a poor user experience.

The present invention intends to provide a waterproof structure for a transmission cable to eliminate the shortcomings mentioned above.

### SUMMARY OF THE INVENTION

The present invention relates to a waterproof structure for a transmission cable, and comprises a transmission cable. A sleeve has a through hole defined axially therethrough, and the sleeve is mounted to the transmission cable. Multiple ribs are circumferentially formed on an outer peripheral surface of the sleeve. Each rib extends outwardly from the outer peripheral surface of the sleeve. The ribs are spaced apart from the others. Each rib is deformed when subjected to pressure.

The primary object of the present invention is to provide a transmission cable with waterproof capabilities. When the transmission cable is electrically connected to a socket, it can effectively seal the socket's interface, preventing external liquids from seeping in and affecting the electrical transmission. This improvement addresses the issue found in conventional technology, where the transmission cable plug, after being inserted into the socket, leaves gaps in the socket interface. These gaps allow moisture from the air and external liquids to easily seep into the socket, impacting the electrical connection between the transmission cable and the socket.

The advantages of the present invention are as follows:

Utilizing the arrangement of the ribs, the transmission cable can determine which rib seals the socket interface based on the depth of insertion. Each rib end, which is distant from the sleeve, presses against the inner wall of the socket. This effectively prevents external moisture, liquids, and other contaminants from entering the socket, thereby protecting and maintaining the electrical connection between the transmission cable and the socket. This also enhances the lifespan of the transmission cable. Therefore, when the cables of electrical devices need to be connected in humid environments, using the sleeve with multiple ribs can achieve stable transmission. Additionally, due to its simple structure, this design can achieve excellent waterproofing at a low cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show that sleeve of the present invention installed on a transmission cable;

FIG. 2 is another perspective view of the sleeve of the present invention installed on a transmission cable from a different angle;

FIG. 3 is an exploded view of the sleeve of the present invention and the transmission cable;

FIG. 4 is a perspective view of the sleeve of the present invention;

FIG. 5 is a cross-sectional view, taken along line V-V of FIG. 4;

FIG. 6 is a plan view of FIG. 4;

FIG. 7 is a usage state diagram showing the transmission cable of FIG. 1 inserted into a socket;

FIG. 8 is an exploded state diagram of FIG. 7 showing the transmission cable not yet inserted into the socket, and

FIG. 9 is a cross-sectional view, taken along line IX-IX of FIG. 7.

### DETAILED DESCRIPTION OF THE PREFERRED EMBODIMENT

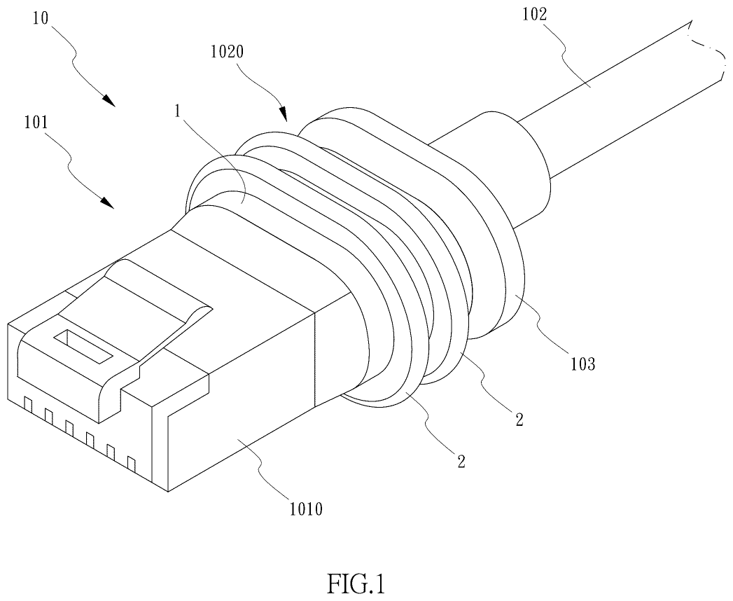

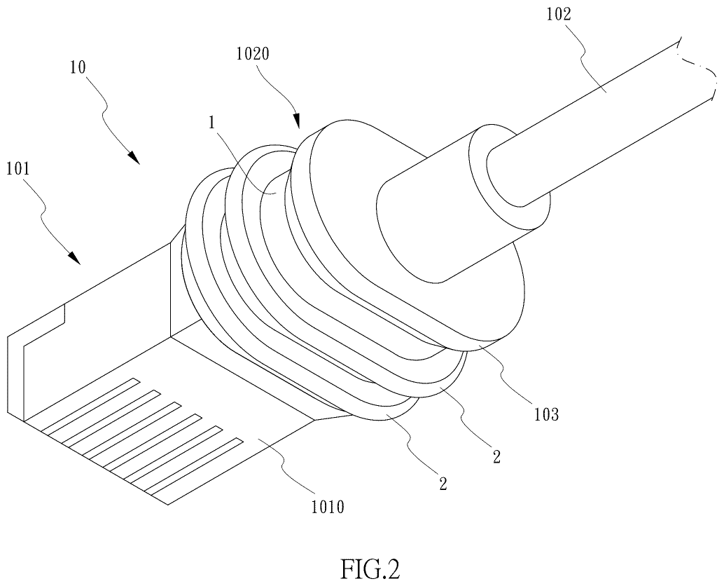

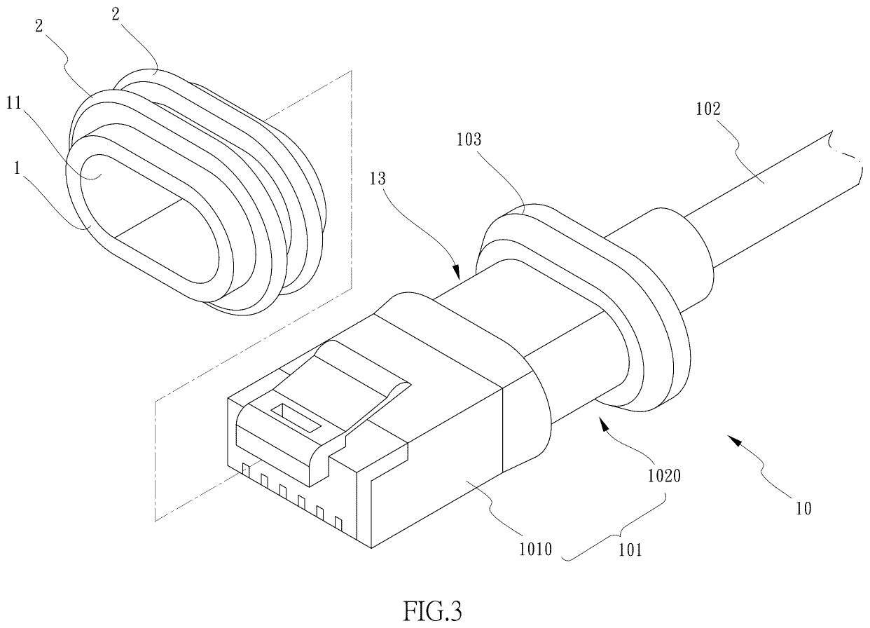

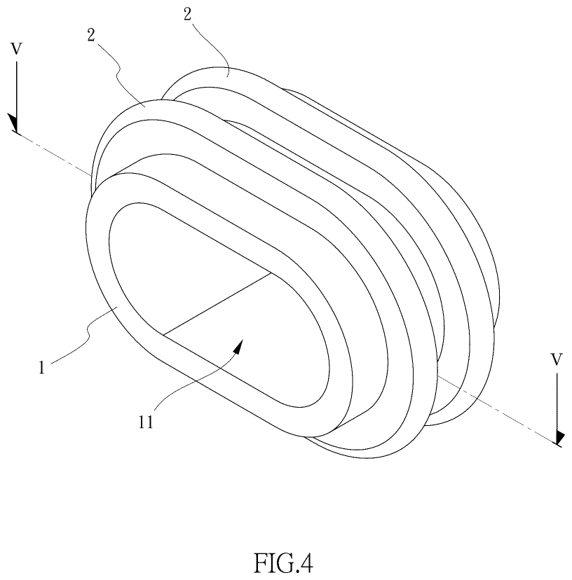

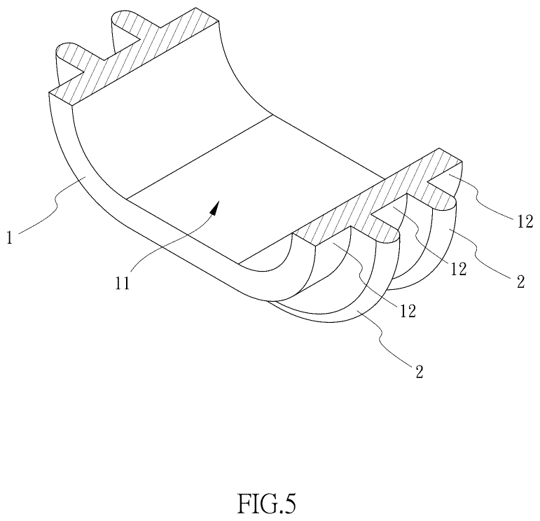

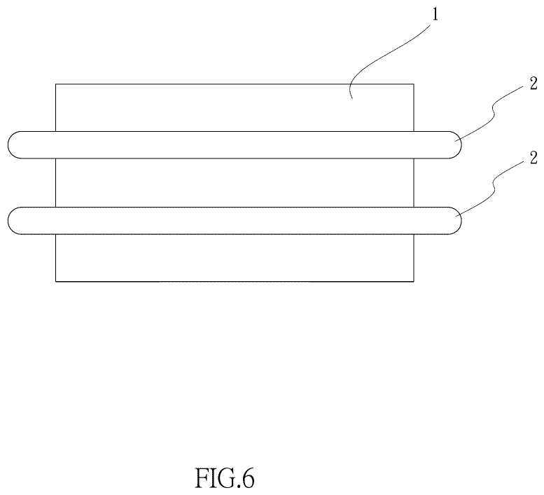

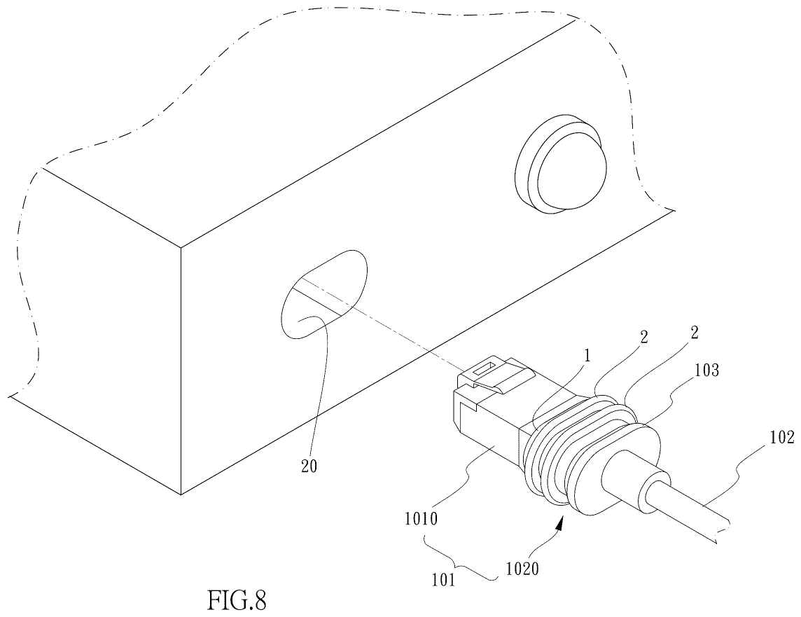

Referring to FIGS. 1 to 9, the waterproof structure for a transmission cable of the present invention comprises a transmission cable (10), and a sleeve (1) has a through hole (11) defined axially therethrough. The sleeve (1) is a cylindrical sleeve and mounted to the transmission cable (10). Multiple ribs (2) are circumferentially formed on an outer peripheral surface of the sleeve (1). Each rib (2) extends outwardly from the outer peripheral surface of the sleeve (1). The ribs (2) are spaced apart from the others. Each rib (2) is deformed when subjected to pressure.

Preferably, the sleeve (1) is made of a flexible and elastically recoverable material. A periphery of each rib (2) that are distant from the outer peripheral surface of the sleeve (1) are arc-shaped. Each rib (2) protrudes from the outer peripheral surface of the sleeve (1) by 0.3 cm to 0.8 cm. The ribs (2) and the sleeve (1) are integrally formed.

The transmission cable (10) includes a transmission head (101) and a connecting wire (102). The transmission head (101) comprises a plug segment (1010) and a neck segment (1020). The plug segment (1010) is formed to one of two ends of the neck segment (1020), and the connecting wire (102) is connected to another one of the two ends of the neck segment (1020). An annular groove (13) is formed on the neck segment (1020). A bevel section (103) is formed between the neck segment (1020) and the connecting wire (102). The plug segment (1010) of the transmission cable (10) is inserted into the through hole (11) of the sleeve (1). The sleeve (1) is engaged with the annular groove (13), and the outer periphery surface of the sleeve (1) is in flush with two end walls of the annular groove (13).

When users connect electrical devices in a humid environment, they simply need to insert the plug segment (1010) of the transmission head (101) of the transmission cable (10) into a socket (20) for an electrical connection. The ribs (2) will elastically deform and be inserted into the socket (20) tightly against the inner wall of the socket (20). This seals the socket opening, preventing external moisture and liquids from seeping in.

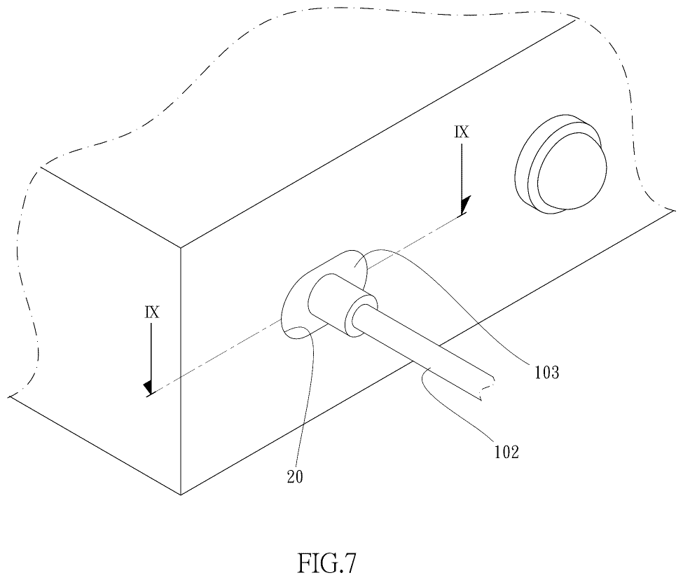

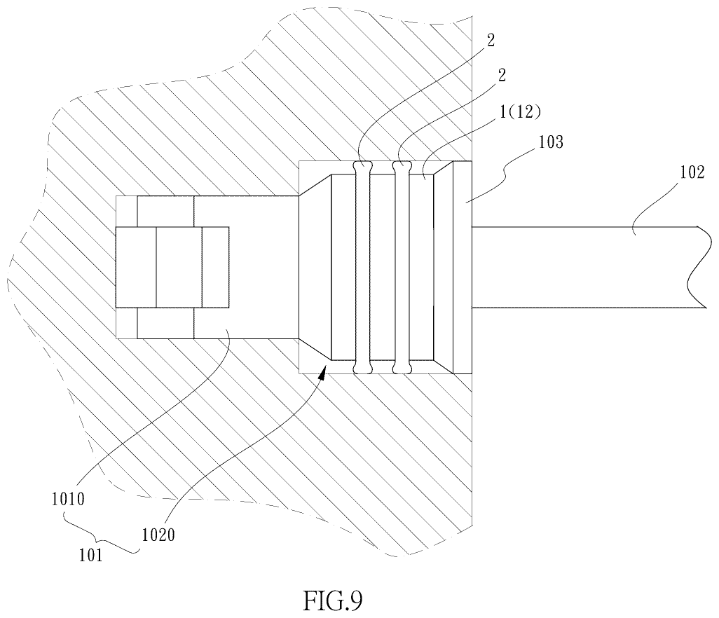

The main purpose of the present invention is to block external liquids (moisture, rainwater, etc.) from entering the socket (20) through its opening. This is achieved using the ribs (2) located outside the sleeve (1). To ensure effective blocking, the ribs (2) must protrude sufficiently to press against the inner wall of the socket (20). Therefore, the sleeve (1) and the ribs (2) are made from materials that can elastically deform and recover, such as highly elastic rubber or silicone. This effectively seals the socket opening and isolates it from external liquids, as shown in FIGS. 7 and 9.

The arrangement of the ribs (2) divides the outer peripheral surface of the sleeve (1) into multiple equal interval sections (12). Each rib (2) is integrally formed with the sleeve (1). The arc-shaped design of the outer surface of each rib (2) ensures a smoother insertion of transmission head (101) of the transmission cable (10) into the socket (20). Additionally, the elastic deformation properties of the ribs (2) allow them to press tightly against the inner wall of the socket's (20) insertion hole, effectively blocking external liquids and moisture.

The ribs (2) are spaced to accommodate different socket depths. Shallow sockets (20) can be sealed by the ribs (2) closer to the transmission head (101) (not shown in the figures), while deeper sockets (20) allow all the ribs (2) to fit inside. This demonstrates the invention's versatile adaptability, as shown in FIGS. 1, 7, and 9.

To ensure the present invention remains securely attached to the transmission cable (10) without slipping off, the annular groove (13) is formed around the neck segment (1020) of the transmission cable (10). The plug segment (1010) of the transmission cable (10) is inserted into the sleeve (1) through the through hole (11) and then moved into alignment with the annular groove (13). The outer peripheral surface of the sleeve (1) aligns flush with the two end walls of the annular groove (13).

Additionally, an outwardly protruding bevel section (103) is formed at the position where the neck segment (1020) is located between the annular groove (13) and the connecting wire (102). The primary purpose of the annular groove (13) is to fix the sleeve (1) in place, preventing it from slipping off when inserted into the socket (20). The bevel section (103) is designed to stop the sleeve (1) from detaching in the direction of the connecting wire (102). This arrangement is illustrated in FIG. 1.

While we have shown and described the embodiment in accordance with the present invention, it should be clear to those skilled in the art that further embodiments may be made without departing from the scope of the present invention.

What is claimed is:

1. A waterproof structure for a transmission cable, comprising:
a transmission cable (10);
a sleeve (1) having a through hole (11) defined axially therethrough, the sleeve (1) mounted to the transmission cable (10), and
multiple ribs (2) circumferentially formed on an outer peripheral surface of the sleeve (1), each rib (2) extending outwardly from the outer peripheral surface of the sleeve (1), the ribs (2) being spaced apart from the others, each rib (2) being deformed when subjected to pressure.

2. The waterproof structure for a transmission cable as defined in claim 1, wherein the sleeve (1) is made of a flexible and elastically recoverable material.

3. The waterproof structure for a transmission cable as defined in claim 1, wherein the transmission cable (10) includes a transmission head (101) and a connecting wire (102), the transmission head (101) comprises a plug segment (1010) and a neck segment (1020), the plug segment (1010) is formed to one of two ends of the neck segment (1020), the connecting wire (102) is connected to another one of the two ends of the neck segment (1020), an annular groove (13) is formed on the neck segment (1020), a bevel section (103) is formed between the neck segment (1020) and the connecting wire (102).

4. The waterproof structure for a transmission cable as defined in claim 3, wherein the plug segment (1010) of the transmission cable (10) is inserted into the through hole (11) of the sleeve (1), the sleeve (1) is engaged with the annular groove (13), the outer periphery surface of the sleeve (1) is in flush with two end walls of the annular groove (13).

5. The waterproof structure for a transmission cable as claimed in claim 1, wherein a periphery of each rib (2) that are distant from the outer peripheral surface of the sleeve (1) are arc-shaped, and each rib (2) protrudes from the outer peripheral surface of the sleeve (1) by 0.3 cm to 0.8 cm.

6. The waterproof structure for a transmission cable as claimed in claim 1, wherein the ribs (2) divide the outer peripheral surface of the sleeve (1) into multiple equal interval sections (12).

7. The waterproof structure for a transmission cable as claimed in claim 1, wherein the ribs (2) and the sleeve (1) are integrally formed.
